(19) United States
(12) Patent Application Publication
(10) Pub. No.: US 2015/0288948 A1
(43) Pub. Date: Oct. 8, 2015

(54) SYSTEM AND METHOD FOR NIGHT VISION OBJECT DETECTION AND DRIVER ASSISTANCE

(71) Applicant: TK HOLDINGS INC., Auburn Hills, MI (US)

(72) Inventors: Gregory Gerhard SCHAMP, South Lyon, MI (US); Mario Joseph HADDAD, Bloomfield Hills, MI (US); Michael John HIGGINS-LUTHMAN, Livonia, MI (US); Truman SHEN, Farmington Hills, MI (US)

(73) Assignee: TK HOLDINGS INC., Auburn Hills, MI (US)

(21) Appl. No.: 14/681,723

(22) Filed: Apr. 8, 2015

Related U.S. Application Data
(60) Provisional application No. 61/976,930, filed on Apr. 8, 2014.

(51) Int. Cl. H04N 13/02; G02B 5/20; H04N 5/33; G06K 9/46; B60R 1/00; G06K 9/62

(52) U.S. Cl. CPC H04N 13/025; B60R 1/00; G06K 9/6201; H04N 5/33; G06K 9/46; G02B 5/20; B60R 2300/107; B60R 2300/8053

(57) ABSTRACT

A stereo vision system includes a first camera sensor and a second camera sensor. The first camera sensor is configured to sense first reflected energy and generate first sensor signals based on the sensed first reflected energy. The second camera sensor is configured to sense second reflected energy and generate second sensor signals based on the sensed second reflected energy. The stereo vision system further includes a processor configured to receive the first sensor signals from the first camera sensor and configured to receive the second sensor signals from the second camera sensor. The processor is configured to perform stereo matching based on the first sensor signals and the second sensor signals. The first camera sensor is configured to sense reflected energy that is infrared radiation. The second camera sensor is configured to sense reflected energy that is infrared radiation.

### CROSS REFERENCE TO RELATED APPLICATIONS

This application claims priority to and the benefit of U.S. Provisional Patent Application No. 61/976,930, filed Apr. 8, 2014. The foregoing provisional application is incorporated by reference herein in its entirety.

### BACKGROUND

The present disclosure relates generally to the field of stereo vision systems. More particularly, the disclosure relates to a stereo vision system having characteristics for improved operation during low-light conditions, and to methods for detecting and tracking objects during low-light conditions.

A stereo vision system may be incorporated into a vehicle so as to provide for viewing of a region in front of the vehicle during nighttime conditions and other low-ambient conditions and may include a plurality of camera sensors. Stereo vision systems can be used to detect objects and estimate the position of objects in the path of the vehicle in three dimensions. The detection and estimation can be obtained from a slightly different projection of the objects on two camera sensors positioned with a horizontal offset between them. The difference between the images of the two sensors is called horizontal disparity. This disparity is the source of the information for the third dimension of the position.

A typical stereo vision system may be equipped with two identical camera sensors with parallel boresight vectors. The two camera sensors are positioned with an offset in a direction that is orthogonal to the boresight vectors. This offset or separation is called the baseline separation. The baseline separation and the tolerance of collinearity between the boresights of the two vision sensors impact the three-dimensional accuracy.

A radar, for example a monopulse radar, is typically equipped with two receive and/or two transmit apertures with a boresight angle and relative positioning that is chosen in a way similar to the stereo vision sensor described above. For example, in a radar with two receive apertures, the back scatter from a target that reaches one of the receive apertures typically reaches the other aperture with a slightly longer or shorter return path length. The difference in the return path length is used to compute the angle of the target with respect to a reference angle.

Like most vision systems, camera sensors for a stereo vision system inevitably suffer from adverse illumination and weather conditions when the assistance is needed most. In low-light conditions, such as between dusk and dawn, the timing of camera exposure may be increased. As a result, the integrity of an image captured from two camera sensors may be sufficiently degraded so that a system or method cannot determine the horizontal disparity between the two sensors. Therefore, a need exists for a system and method to measure the horizontal disparity between camera sensors during low-light conditions.

### SUMMARY

One disclosed embodiment relates to a stereo vision system for use in a vehicle. The stereo vision system includes a first camera sensor and a second camera sensor. The first camera sensor is configured to sense first reflected energy and generate first sensor signals based on the sensed first reflected energy. The second camera sensor is configured to sense second reflected energy and generate second sensor signals based on the sensed second reflected energy. The stereo vision system further includes a processor configured to receive the first sensor signals from the first camera sensor and configured to receive the second sensor signals from the second camera sensor. The processor is configured to perform stereo matching based on the first sensor signals and the second sensor signals. The first camera sensor is configured to sense reflected energy that is infrared radiation. The second camera sensor is configured to sense reflected energy that is infrared radiation.

Another disclosed embodiment relates to a stereo vision system for use in a vehicle. The stereo vision system includes a first camera sensor, a second camera sensor, and a third camera sensor. The first camera sensor is configured to sense first reflected energy and generate first sensor signals based on the sensed first reflected energy. The second camera sensor is configured to sense second reflected energy and generate second sensor signals based on the sensed second reflected energy. The third camera sensor is configured to sense third reflected energy and generate third sensor signals based on the sensed third reflected energy. The stereo vision system further includes a processor configured to receive the first sensor signals from the first camera sensor, configured to receive the second sensor signals from the second camera sensor, and configured to receive the third sensor signals from the third camera sensor. The processor is further configured to perform stereo matching based on at least one of the first sensor signals, the second sensor signals, and the third sensor signals. The first camera sensor is configured to sense reflected energy that is visible radiation. The second camera sensor is configured to sense reflected energy that is visible radiation. The third camera sensor is configured to sense energy that is infrared radiation.

Still another disclosed embodiment relates to a method for stereo vision in a vehicle. The method includes sensing first reflected energy using a first camera sensor; generating first sensor signals based on the sensed first reflected energy; sensing second reflected energy using a second camera sensor; generating second sensor signals based on the sensed second reflected energy; and performing stereo matching based on the first sensor signals and the second sensor signals. The first reflected energy is infrared radiation. The second reflected energy is infrared radiation.

### BRIEF DESCRIPTION OF THE DRAWINGS

FIG. 1 illustrates a comparison of a stereo range map generated by a stereo vision system, between a typical daytime scenario and typical nighttime scenario.

FIG. 2 illustrates a stereo camera system of the stereo vision system, including a left camera, and right camera.

FIG. 3 is a flow chart of a process for detecting, tracking, and classifying an object from the stereo range map generated by the stereo camera system; the stereo range map computed using left camera images and right camera images.

FIG. 4 illustrates quantum efficiency of the center camera of the stereo camera system.

FIG. 5 illustrates a stereo range map generated using the left camera image and right camera image of the stereo camera system, the cameras operated with passive illumination.

FIG. 6 illustrates an overlapped diffused conic beam projected from a vehicle headlight, illustrating an illumination process of the stereo vision system.

FIG. 7 illustrates nighttime stereo imagery of the left camera and right camera of the stereo camera system and the resulting stereo range map generated by the stereo vision system.

FIG. 8 illustrates a stereo camera system of the stereo vision system, including a left camera, right camera, and center camera.

FIG. 9 is a flow chart of a process for detecting, tracking, and classifying an object from the stereo range map generated by the stereo camera system of FIG. 8; the stereo range map computed using left-center camera images and center-right camera images.

FIGS. 10A-10B illustrate stereo vision geometry for a left camera and right camera of the stereo camera system, and more generally the process of computing a range map.

FIG. 11 illustrates stereo vision geometry for a left camera and right camera with a narrow baseline and wide baseline.

FIG. 12 is a graph illustrating disparity between images captured by the left camera and right camera of the stereo camera system, for a narrow baseline and wide baseline configuration.

FIG. 13 is a table illustrating disparity levels for images captured by the left camera and right camera of the stereo camera system, for a narrow baseline and wide baseline configuration.

FIG. 14 illustrates intensity images acquired from the stereo camera system in a combined narrow baseline and wide baseline configuration.

FIG. 15 illustrates a combined range map generated from the intensity images illustrated in FIG. 14.

### DETAILED DESCRIPTION

Referring generally to the figures, systems and methods for night vision object detection and driver assistance are shown and described. Various sensor technologies, sensor configurations, and illumination techniques are disclosed that may be used to overcome issues relating to the stereo vision system (SVS) operating in nighttime or other low ambient environments.

The stereo vision system may include a camera system including a plurality of camera sensors for sensing objects. The stereo vision system includes a stereo camera system including two cameras sensing reflected energy in the wavelength interval from 0.9 to 1.8 microns (900 to 1800 nanometers). The stereo vision system is equipped with eye-safe supplemental illumination selectively activated during low-light conditions The stereo camera system may optionally include a third central camera that may be used for data fusion techniques to add further capabilities to the stereo vision system.

Typical stereo vision systems have improved object detection and tracking capabilities throughout many environmental conditions. However, overall system performance can be limited under scenarios involving low ambient illumination (e.g., in the shadows of buildings or trees, in tunnels, and in covered parking garages) and nighttime operation at distances beyond the vehicle's headlight pattern (e.g., 30 meters while using low-beam headlights and 50 meters while using high-beam headlights).

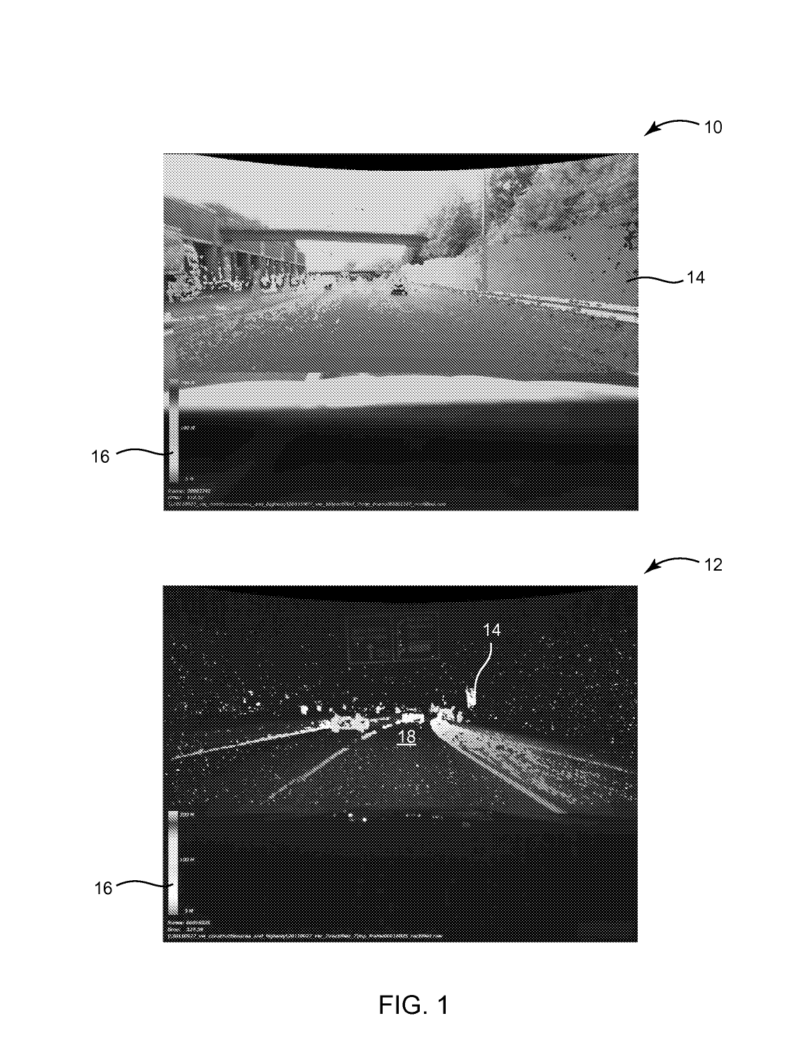

Referring now to FIG. 1, a comparison of stereo range maps generated by a typical stereo vision system is illustrated, illustrating a typical daytime scenario 10 and typical nighttime scenario 12. The comparison of the images shows the characteristic differences between day and night performance of the stereo vision system. The stereo range map is over-plotted onto a left camera image for a typical daytime and nighttime scenario. The colored regions 14 of each stereo range map show a valid stereo range fill using the range scale 16 shown in the lower left of each image. The night scenario 12 shows a drastic reduction of range fill from the roadway along the host vehicle's path and from the upper half of the target vehicles. In some embodiments, stereo ranging is intentionally limited to a maximum elevation (e.g., 4 meters), which may prevent range fill in the upper regions during the daytime scenario 10.

Successful stereo ranging relies on measuring disparities (column shifts) between correlated structures as they appear in the left and right images captured by the cameras of the stereo vision system. In low ambient conditions, camera exposure timing increases. This in turn degrades the left and right image quality (the image regions become blurred and defocused) and eventually the search for correlated structures between the left and right images can fail. The black regions 18 in the stereo range maps of FIG. 1 are indicative of this condition.

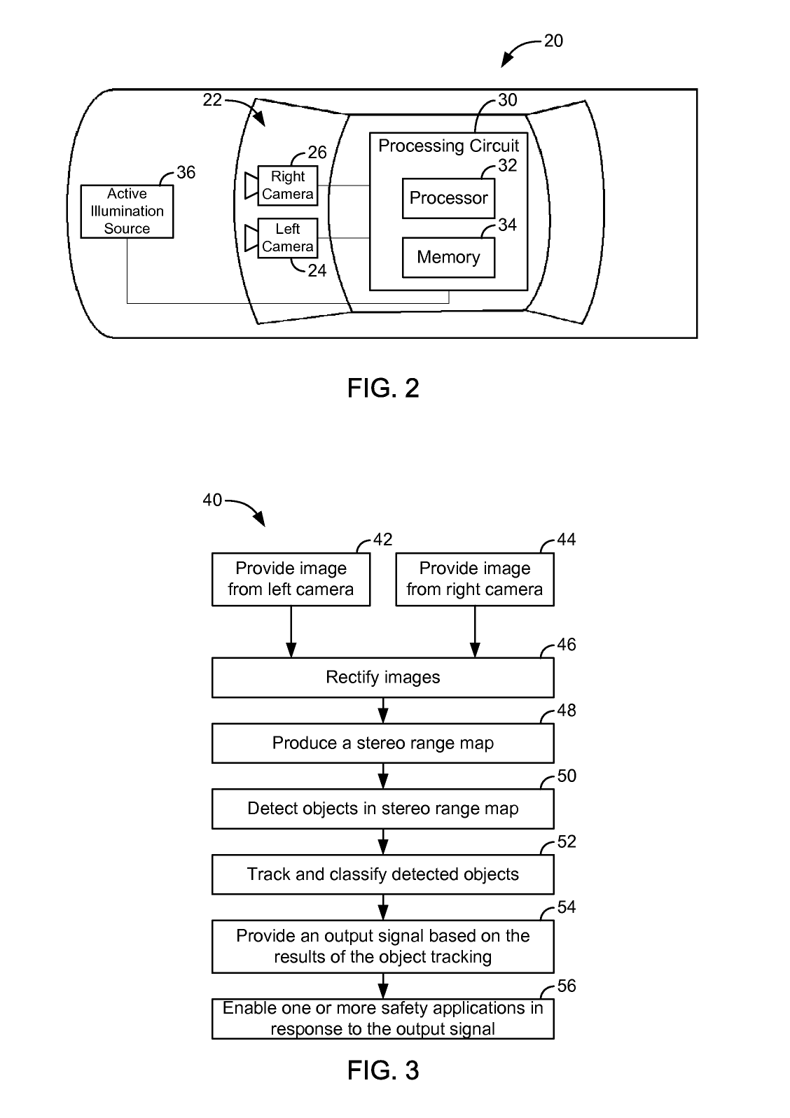

FIG. 2 illustrates a stereo camera system 22 of a stereo vision system (SVS) 20, including a left camera 24, right camera 26. The stereo camera system 22 is shown integrated with a vehicle; it should be understood that the stereo camera system 22 of the SVS 20 and vehicle may be implemented in any location in a vehicle. The stereo camera system 22 operates in the short wave infrared (SWIR) band.

The stereo vision system 20 of the present disclosure may include a processing circuit 30 including a processor 32 and memory 34 for completing the various activities described herein. The processor 32 may be implemented as a general purpose processor, an application specific integrated circuit (ASIC), one or more field programmable gate arrays (FPGAs), a group of processing components, or other suitable electronic processing components. The memory 34 is one or more devices (e.g., RAM, ROM, flash memory, hard disk storage, etc.) for storing data and/or computer code for completing and/or facilitating the various user or client processes, layers, and modules described in the present disclosure. The memory 34 may be or include volatile memory or non-volatile memory, and may include database components, object code components, script components, or any other type of information structure for supporting the various activities and information structures of the present disclosure. The memory 34 is communicably connected to the processor 32 and includes computer code or instruction modules for executing one or more processes described herein.

The stereo vision system 20 of the present disclosure may further include a supplemental or active illumination source or component 36. The illumination source 36 may be utilized to provide illumination (e.g., infrared illumination) to allow the stereo camera system 22 to capture images in scenes devoid of light (i.e., driving in non-illuminated tunnels and parking garages or driving under thick forest canopies, etc.).

The systems and methods of the present disclosure provide for a sensing mode implementable using the stereo camera system 22 of FIG. 2. In one embodiment, the stereo camera system 22 includes two or more cameras capable of sensing energy in the wavelength interval from 0.9 to 1.8 microns (900 to 1800 nanometers). The cameras' focal plane array or energy sensitive area include an infrared detector formed from a suitable material, such as Indium Gallium Arsenide (InGaAs), also known as Gallium Indium Arsenide (GaInAs). An example of the forward-looking SWIR stereo camera system 22 is shown in FIG. 2. This sensing mode may use the left camera 24 and right camera 26 of the stereo camera system 22.

Sensing in the SWIR band shares a similarity with sensing in the human-visible band (the wavelength interval from 0.35 to 0.7 microns or 350 to 700 nanometers). SWIR light is reflective light, reflected off object surfaces much like light in the human-visible band. Therefore, imagery from the camera operating in the SWIR band may be processed using established machine vision techniques developed from imagery collected with cameras capable of sensing in the human-visible band. Images from the camera of the SWIR system constructed from InGaAs are comparable to images from cameras constructed from Silicon Oxides (sensing in the human-visible band) in angular resolution and spatial detail.

Stereo matching of the imagery from the left camera 24 and right camera 26, from the stereo camera system 22 operating in the visible band produces a stereo range map (or stereo disparity map). The stereo matching of the imagery may be accomplished using one or more of the well-known methods (e.g., CENSUS, sum of absolute differences (SAD), or normalized cross correlation (NCC)). The stereo matching of the imagery may be carried with the processing circuit 30 of the stereo vision system 20, a component thereof (e.g., processor 32, memory 34, etc.), or with another data processing element in communication with the processing circuit 30. Downrange measurements at pixel locations are correlated with either the left camera pixel locations or right camera pixel locations. The elements of the stereo range map (or stereo disparity map) are commonly referred to as “range pix” or “range pixels.”

The stereo range map may be used as the basis for various modules of the stereo vision system 20 (e.g., for object detection, object tracking, and collision likelihood) and for various vehicle subsystems and applications such as forward collision warning, automatic emergency braking, adaptive cruise control, child back-over protection, etc. Such examples of machine vision algorithms are disclosed in U.S. Patent Application No. 2013/0251194, U.S. Pat. No. 8,509,523, and U.S. Pat. No. 8,594,370, all of which are incorporated by reference herein. It should be understood that the stereo range map may be used for any other type of vehicle subsystem or application.

Referring to FIG. 3, a flow chart of a process 40 for detecting, tracking, and classifying an object from the stereo range map generated by the stereo camera system 22 is shown. The stereo range map is computed using multiple images captured by the stereo camera system. According to an exemplary embodiment, a left camera image is provided by the left camera 24 (step 42) and a right camera image is provided by the right camera 26 (step 44), as described above.

The left image and right image provided by the left camera and right camera are rectified (step 46). Image rectification may generally include removing lens distortion from the left and right camera images and bringing the left and right camera images into epipolar alignment.

The rectified image is used to produce a stereo range map (step 48). The stereo range map may be computed using one or more well-known methods (e.g., CENSUS, SAD, NCC, etc.), as described above.

The stereo range map is analyzed to detect objects (step 50). The object detection generally includes the process of identifying legitimate objects in the images, separating foreground and background objects in the images, and computing positional measurements for each object relative to the vehicle (e.g., calculating the down range, cross range, height, or elevation of the object relative to the vehicle).

The objects detected in the object detection step are tracked and classified (step 52). This includes identifying associated objects in consecutive video frames captured by the cameras, estimating kinematic properties of the objects, and classifying the objects into pre-defined categories (e.g., vehicle, pedestrian, bicyclist, etc.).

An output signal is provided based on a result of the object tracking (step 54) in order to provide assistance to a driver of the vehicle. For example, the processor 32 may provide an output signal to a vehicle system, or safety application. Based on the objects tracked and classified, one or more safety applications may be enabled (step 56). The safety applications activated may be various types of applications for assisting the driver. Examples of such applications may include a forward collision warning (FCW) system, an automatic emergency braking (AEB) system, an adaptive cruise control (ACC) system, and a child back-over protection (CBP) system. In further embodiments, other safety applications or other applications may be enabled based on the object tracking and classification. In further embodiments, the output signal may be relayed to the driver of the vehicle, such as with a display (e.g., center stack display, dashboard display, heads-up display, etc.) and/or an audio, tactile, or visual alarm device.

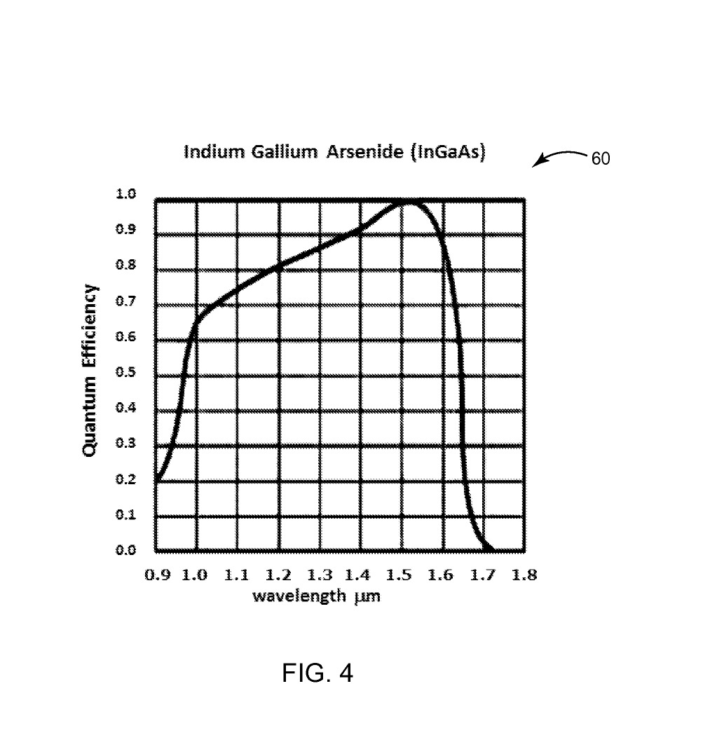

Referring to FIG. 4, a graph 60 illustrating the quantum efficiency of InGaAr is shown at various wavelengths. Sensing in the SWIR band provides an advantage over sensing in the human-visible band with cameras constructed from Silicone Oxides. Particularly, SWIR cameras constructed from InGaAs can operate better at night due to their high quantum efficiency (as illustrated in the graph of FIG. 4), nearly 100% pixel fill factor, and extremely low noise in the readout circuitry. The pixel fill factor refers to the percentage of a photo-site (a pixel on an image sensor) that is sensitive to light over a particular wavelength interval. When the fill factor is lower, the sensor is less sensitive during low-light conditions. CMOS (Complementary Metal Oxide Semiconductor) cameras require circuitry at each photo-site to filter noise and perform other functions. These cameras typically have a maximum pixel fill factor of 50%.

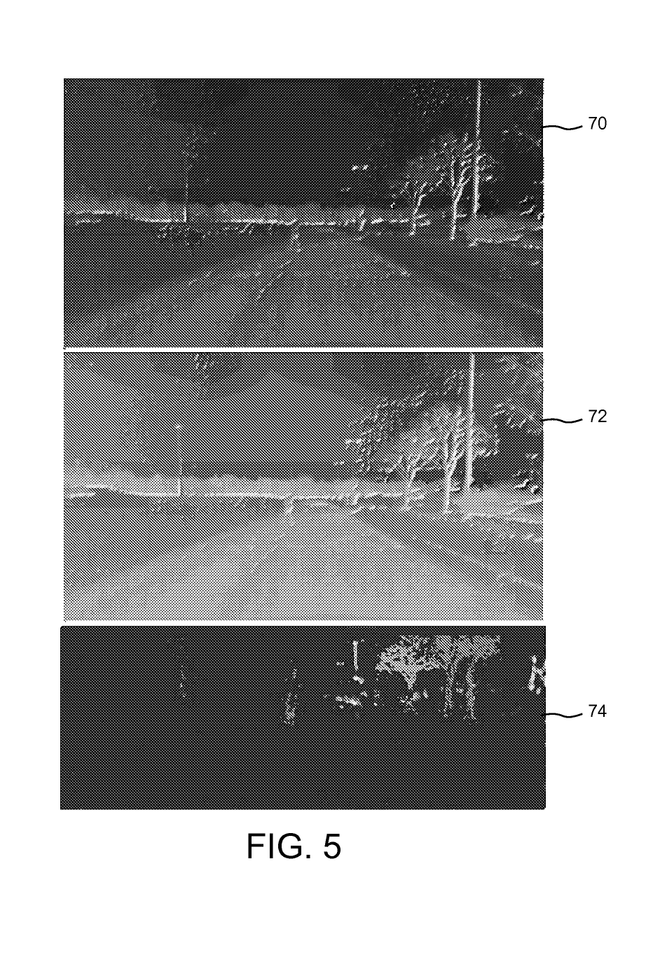

Referring now to FIG. 5, an exemplary left camera image 70, right camera image 72 and stereo range map 74 are shown. The exemplary left camera image 70 and right camera image are provided by SWIR cameras constructed of InGaAs. The cameras were operated passively without supplemental or active illumination. Cameras constructed from InGaAs benefit from an atmospheric phenomenon called night sky irradiance or night glow. Night sky irradiance is an emission of low light in the upper atmosphere caused by the recombination of particles photo ionized by the sun, luminescence from cosmic rays striking the upper atmosphere, and chemo luminescence caused by oxygen and nitrogen reacting with hydroxyl ions. This offers the possibility to successfully operate cameras constructed from InGaAs at night, passively without supplemental or active illumination. Night sky irradiance is present in the SWIR band where InGaAs cameras reach peak efficiency. Night sky irradiance is not detectable in the human-visible band or by cameras constructed from Silicone Oxides.

In some embodiments, SWIR cameras constructed from InGaAs cannot deliver optimal or timely results in scenes devoid of light (i.e., driving in non-illuminated tunnels and parking garages or driving under thick forest canopies). Many vehicle subsystems or applications (e.g., FCW, AEB, ACC, and CBP as described above) require high scene sampling rates (camera frame rates of at least 30 frames per second) to establish reliable levels for the enabling of machine vision algorithms (object detection, object classification, object tracking, and collision likelihood). The frame rate requirement greatly limits a camera's maximum allowable integration or exposure timing (the time given to accumulate light energy for a single image frame).

In such cases, supplemental illumination generated by the supplemental or active illumination source or component 36 may be provided. In one embodiment, the supplemental or active illumination source 36 may include laser diodes. The illumination generated from the laser diodes may emit energy in the wavelength interval from 1.2 to 1.8 microns (1200 to 1800 nanometers). Laser energy in a sub-region of this wavelength interval is qualified as eye safe by The Center for Devices and Radiological Health (CDRH), a branch of the United States Food and Drug Administration (FDA) responsible for the radiation safety performance of non-medical devices which emit electromagnetic radiation. The CDRH eye safety qualification specifically includes laser energy emissions from 1.4 to 1.6 microns (1400 to 1600 nanometers).

Supplemental illumination in the SWIR band is suitable for automotive safety applications and other vehicle subsystems and applications. Illumination in the SWIR band is not human-visible and therefore would not distract the driver of the equipped vehicle and does not interfere with the vision of drivers in the oncoming vehicles. The illumination generated from the laser diodes may be compactly integrated into a vehicle's headlight assembly for forward-looking safety applications and integrated in a vehicle's taillight assembly for rear-looking safety applications.

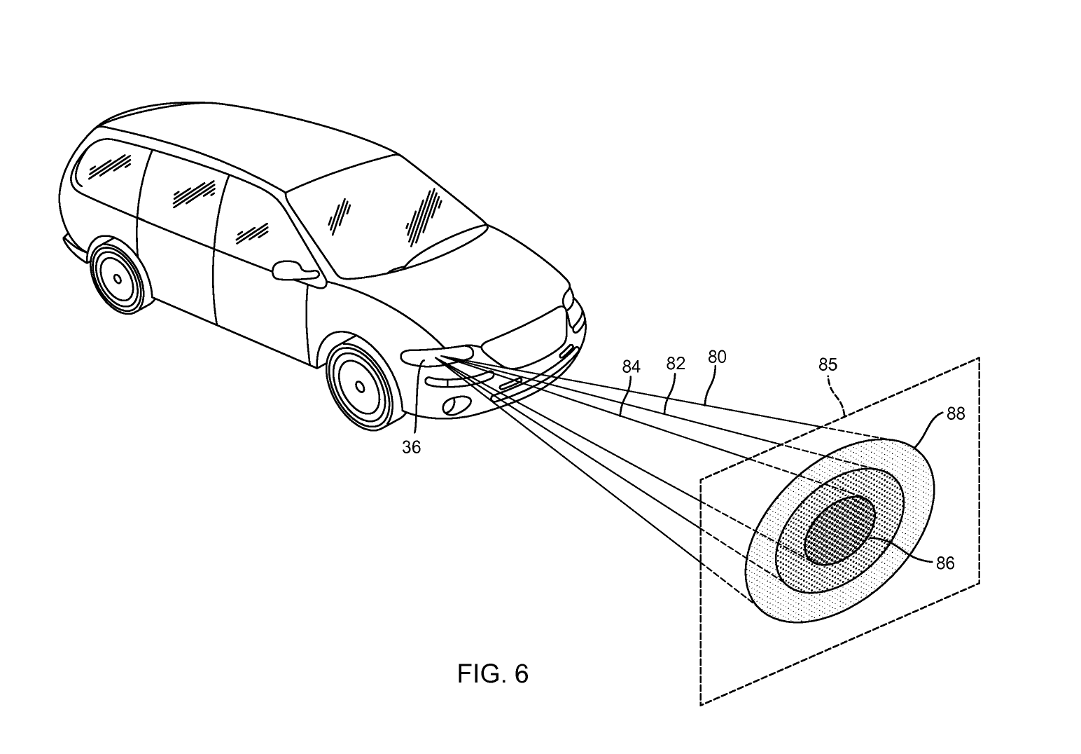

Referring now to FIG. 6, the supplemental (or active) illumination generated from the illumination source 36 may be changed between a collimated beam and a diffused conic beam. According to an exemplary embodiment, the illumination source 36 includes a specialized optical filter to change the illumination between a collimated beam and a diffused conic beam. The conic beam may be circular (symmetric width and height) or elliptical (asymmetrical width and height) within a specified dispersion angle. Automotive safety applications typically require an elliptical conic beam with the width greater than the height. Specialized optical filters of this type may be commercially available and fully compatible with laser emissions in the wavelength interval from 1.4 to 1.6 microns (1400 to 1600 nanometers). The supplemental (or active) illumination may be either constantly on (continuous) or cycled between on and off states (pulsed) with the on state synchronized to the camera exposure interval (i.e., the supplemental illumination is being projected while the camera is accumulating reflected light energy in the wavelength interval from 1.4 to 1.6 microns).

Supplemental illumination in the SWIR band may also be generated from multiple light sources 36 (e.g., multiple laser diodes emitting energy in the wavelength interval from 1.4 to 1.6 microns). The collimated beam from each light source 36 may be diffused into a conic beam with a unique dispersion angle. The conic beams may be overlapped to form a layered broad-form active illumination region. According to an exemplary embodiment, the one or more light sources 36 may project overlapped diffused conic beams with dispersion angles of 60°, 40°, and 20°. Laser energy diffused into a conic beam has an inverse relationship between dispersion angle and downrange illumination distance. A larger dispersion angle reduces downrange illumination distance. For example, a first conic beam 80 with a dispersion angle of 60° provides a downrange illumination distance of 30 meters, a second conic beam 82 with a dispersion angle of 40° provides a downrange illumination distance of 60 meters, and a third conic beam 84 with a dispersion angle of 20° provides a downrange illumination distance of 90 meters. Overlapped diffused conic beams may be projected from a vehicle's headlight position, as shown in FIG. 6. The overlapped diffused conic beams 80, 82, and 84 are shown intersecting a virtual plane 85. The energy cross-section with the highest energy in the darkest central region 86, corresponds with the conic beam 84 with a dispersion angle of 20°). The overall cross-section region 88 corresponds with the three conic regions 80, 82, and 84.

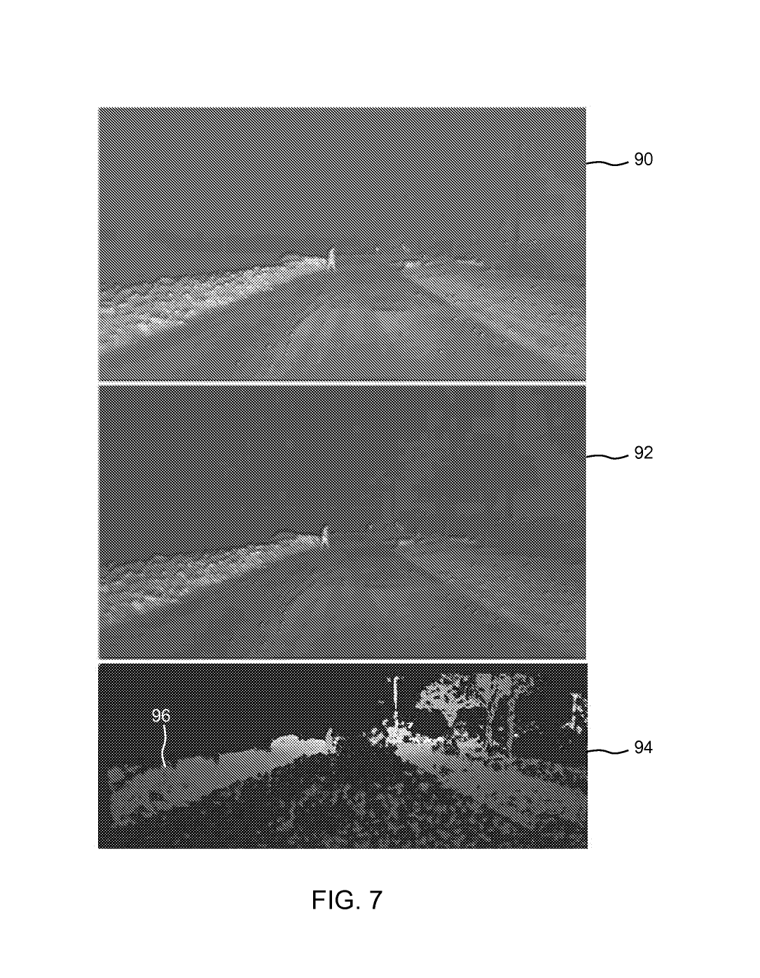

Referring now to FIG. 7, a left camera image 90, a right camera image 92, and a stereo range map 94 are shown, according to an exemplary embodiment. The camera images 90 and 92 are nighttime stereo imagery from the SWIR cameras. The resulting stereo range map is computed with the CENSUS stereo matching method. The images 90 and 92 are shown as images captured by cameras being operated actively with supplemental illumination (e.g., a single diffused conic beam with a 60° horizontal dispersion angle). The stereo range map 94 provides considerably more range fill 96 compared to the stereo range map 74 of FIG. 5 (obtained with passive illumination).

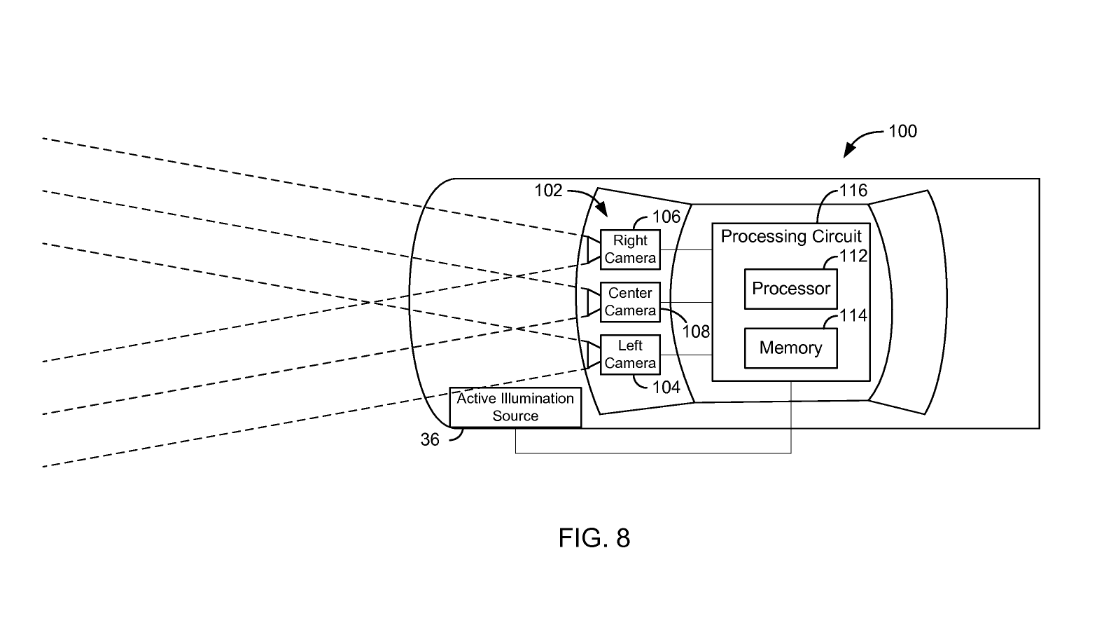

The above describes an embodiment of the stereo camera system incorporating a left camera and right camera (e.g., left camera 24 and right camera 26). Referring now to FIG. 8, a further variant of the stereo vision system described herein includes a third InGaAs camera positioned between the left camera and right camera. A dual baseline stereo camera system 102 of a stereo vision system (SVS) 100, includes a left camera 104, right camera 106, and center camera 108. The stereo camera system 102 is shown integrated with a vehicle; it should be understood that the stereo camera system 102 of the SVS 100 and vehicle may be implemented in any location in a vehicle. The stereo camera system 102 operates in the short wave infrared (SWIR) band. The stereo vision system 100 may further include a processing circuit 116 including a processor 112 and memory 114 for completing the various activities described herein and one or more supplemental or active illumination sources 36. According to one exemplary embodiment, the center camera 108 is identical to the left camera 104 and the right camera 106 (e.g., same field of view and image resolution). The addition of the center camera 108 may enable two alternate stereo matching techniques, composite narrow baseline stereo matching and dual baseline stereo matching as described below.

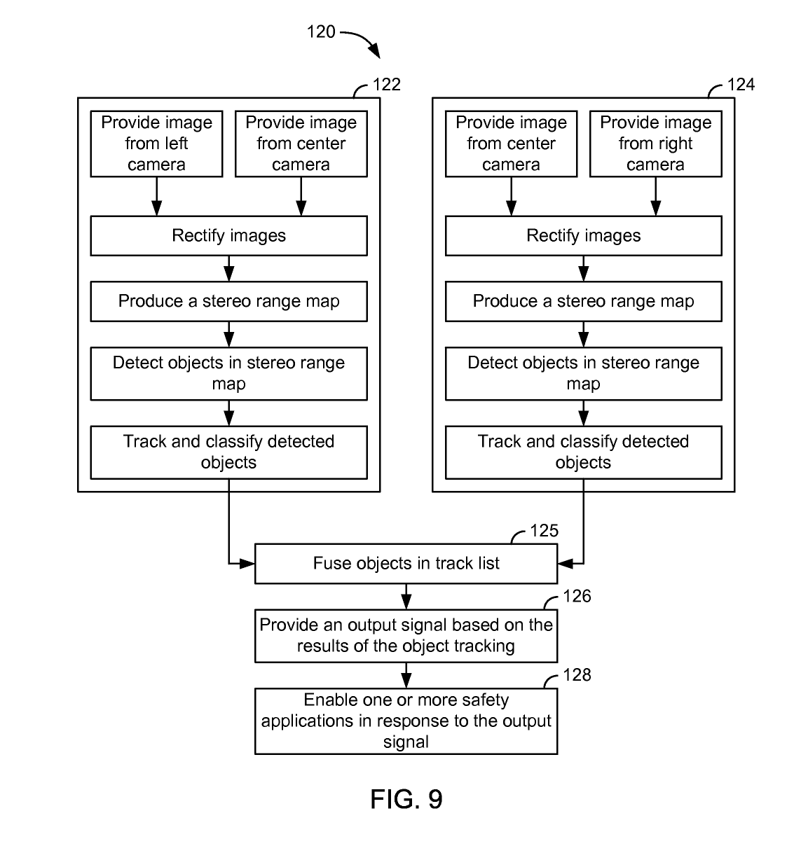

Referring to FIG. 9, a flow chart of a process 120 for detecting, tracking, and classifying an object from the stereo range map generated by the stereo camera system 102 is shown. The process 120 of FIG. 9 illustrates a composite narrow baseline stereo matching process. Composite narrow baseline stereo matching refers to the process of computing two stereo range maps (using the CENSUS, SAD, NCC, or other method) from the left camera 104 and center camera 108 pair and the center camera 108 and right camera 106 pair. The stereo range maps are computed from the intensity images acquired from each of the three cameras (left camera 104, center camera 108, right camera 106) during a discrete time interval. The discrete time interval may be referred to as exposure time or integration time and may be, for example, ½ millisecond during bright sunlight conditions and 25 milliseconds during low-light conditions.

Referring to the process of FIG. 9, the process 120 may differ from the process 40 of FIG. 3 in that the image rectification step, stereo matching step, object detection step, and object tracking and classification step are performed for both a combination of the left camera image and center camera image in a first subprocess 122 and for the center camera image and right camera image in a second sub-process 124. The objects that have been detected, tracked, and classified in consecutive video frames from both the left-center and center-right stereo camera pairs in the sub-processes 122 and 124, respectively are merged (step 125). An output signal is provided based on a result of the object tracking (step 126) in order to provide assistance to a driver of the vehicle. Based on the objects tracked and classified, one or more safety applications may be enabled (step 128).

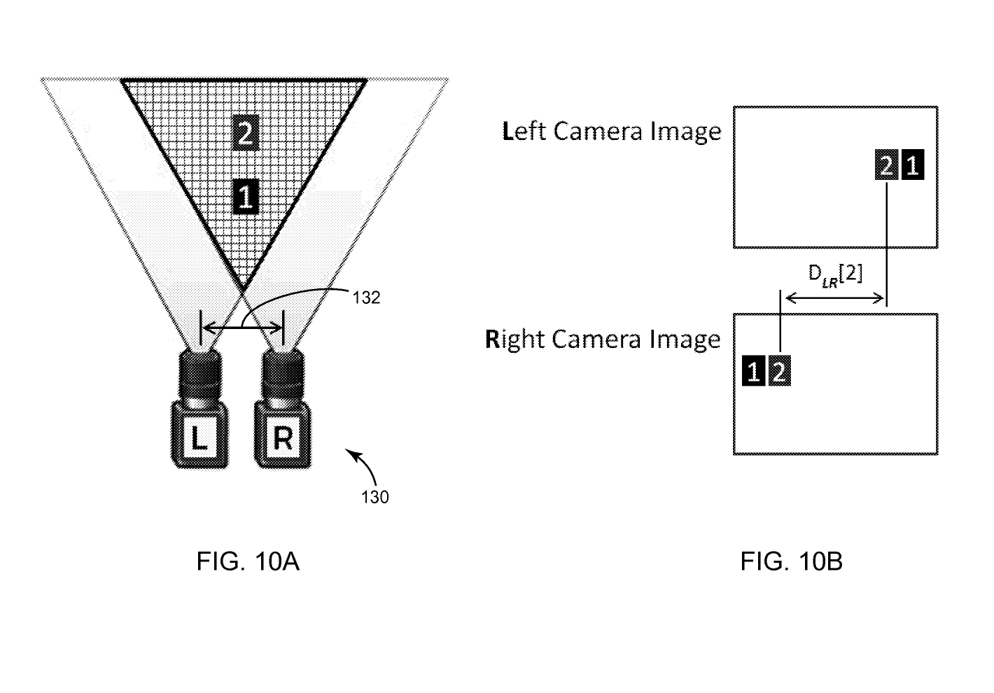

Referring now to FIGS. 10A and 10B, the stereo vision geometry for a two camera system 130 and the process of computing a stereo range map for the two camera system is shown. The downrange of the two cameras may have the following relationship:

Downrange=(Baseline×Focal Length)/Disparity (eq. 1)

FIG. 10A illustrates a bird's eye view of two outward-looking cameras (L and R) with overlapping fields of view (FOVs) and two regions (1 and 2) with differential downrange. FIG. 10B illustrates the appearance of region 1 and region 2 in the left camera image and right camera image captured by the left camera and right camera.

The baseline is the real-world physical distance between the central optical axes of two cameras (illustrated by the arrow 132 in FIG. 10A). The baseline distances may be of any distance (e.g., 120 mm, 165 mm, 200 mm)

The disparity is the image-coordinate distance (in pixels) between corresponding regions in the left camera image and right camera image. The distance is shown as D_{LR}[2] for the disparity corresponding to region 2 in the two images. The regions may be any size from single pixels to arbitrarily-shaped clusters of pixels. The disparity may be computed within, for example, the CENSUS method or another method. Computing the disparity between corresponding pixels (a region of size 1×1) in the left camera image and right camera image results in a stereo range map (or stereo disparity map) with unique downrange measurements for every pixel (commonly referred to as “range pix” or “range pixels”) corresponding to intensity pixels in the left camera image or right camera image. This process gives the highest resolution range map, but is computationally expensive.

The focal length is the calibrated measurement of optical convergence for collimated light rays, or equivalently stated as the distance required to bring parallel light rays to intersect on a single point after passing through the lens. All three cameras of the stereo camera system may use identical lens elements and therefore share the same focal length.

The relationship between downrange, baseline, focal length, and disparity (eq. 1) states the inverse proportionality of downrange and disparity. A large disparity corresponds to a small downrange and a small disparity corresponds to a large downrange. Referring to FIG. 10B, the disparity for region 2 is smaller than the disparity for region 1. Referring to FIG. 10A, the smaller disparity for region 2 corresponds to a larger downrange compared to region 1.

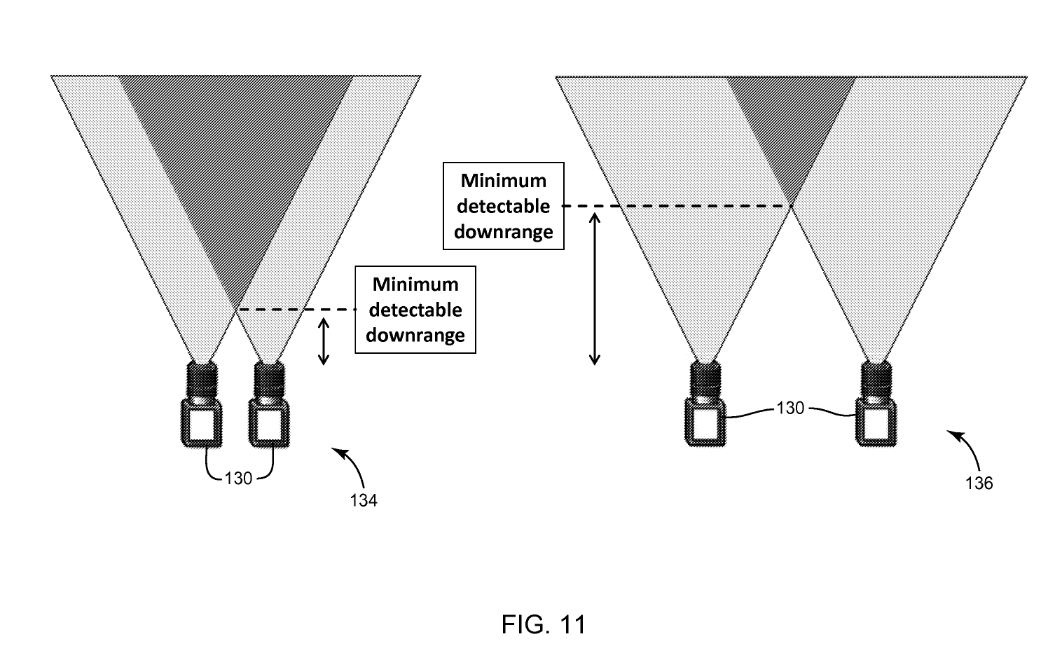

The baseline and focal length may be varied, which may result in various advantages or disadvantages for the stereo vision system. A larger baseline may result in better downrange accuracy; however, this may result in a larger blind zone. Referring to FIG. 11, a minimum detectable downrange is illustrated for a narrow baseline configuration 134 and a wide baseline configuration 136 for the stereo camera system 130. The minimum detectable downrange is located at the vertex of the overlapping FOVs of the cameras.

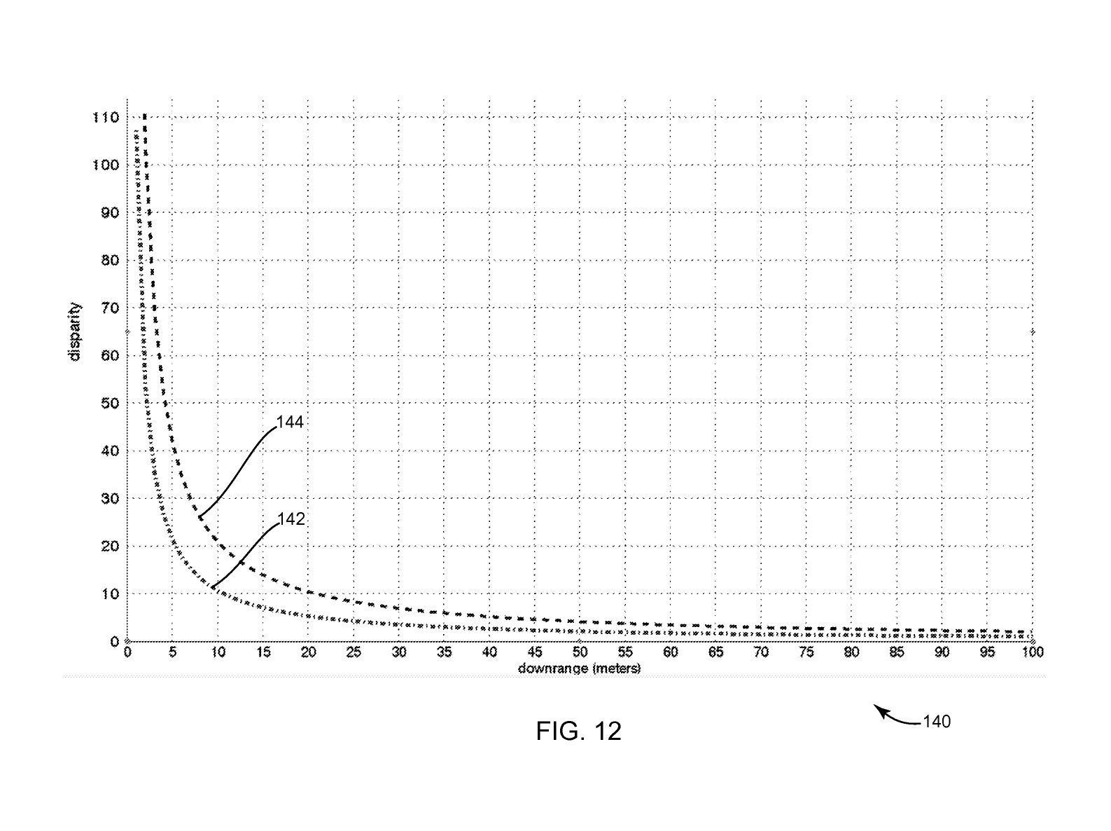

Referring to FIG. 12, a disparity plot 140 for the narrow baseline configuration (line 142) and wide baseline configuration (line 144) is shown. The minimum detectable downrange in the narrow baseline configuration is 1.2 meters, while the minimum detectable downrange for the wide baseline configuration is 3.1 meters.

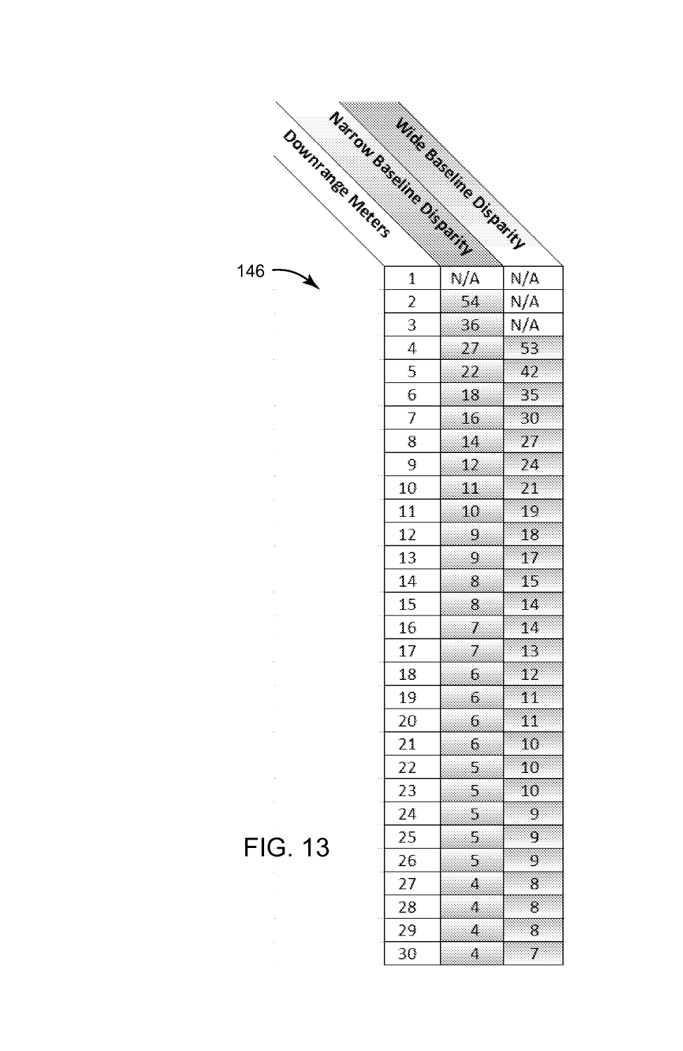

Referring to FIG. 13, a table 146 showing tabulated disparity values for the narrow baseline configuration and wide baseline configuration of the stereo camera systems of FIG. 11 are shown. The disparities are shown only for integer values of downrange from 1 to 30 meters downrange. An “N/A” indicates that the disparity is not available for the corresponding downrange value (it is below the minimum detectable downrange).

FIGS. 12-13 illustrate the large difference in disparity values between the narrow baseline stereo camera system 134 and wide baseline stereo camera system 136. For example, a region at 4 meters downrange may have a relatively small disparity in the narrow baseline stereo camera system 134 (e.g., (e.g., 27 pixels). The same region at 4 meters downrange will have a relatively large disparity in the wide baseline stereo camera system 136 (e.g., 53 pixels) compared to the narrow baseline stereo camera system 134.

As stated above, the disparity is computed within the stereo matching method (CENSUS, SAD, or NCC). In order to find corresponding regions in the left camera image and right camera image, the method searches through all possible disparities. In other words, for a particular intensity pixel (a 1×1 region) in the left camera image, the stereo matching method looks for the best matching pixel in the right camera image over all possible disparities (pixel distances from the current pixel). For a particular stereo camera system, a reduction in the maximum number of disparities geometrically reduces the searching required to optimally match pixels between the left camera image and right camera image. This in turn reduces the execution time for stereo matching, allowing for faster frame rates (acquiring and processing more images within a specified time interval) and possibly running the stereo matching method on a less expensive embedded processor.

Referring again to FIG. 8, the dual baseline stereo camera system 102 uses the intensity images acquired from the left camera 104 and center camera 108 for stereo matching all regions within a first downrange interval (e.g., an interval from 21 meters to 1.2 meters). In other words, for each pixel in the left camera image, the stereo matching method looks for the best matching pixel in the center camera image over all possible disparities in a first range (e.g., a disparity between 6 and 62). The dual baseline stereo camera system 102 uses the intensity images acquired from the left camera 104 and right camera 106 for stereo matching all regions within a second downrange interval (e.g., the interval from 100 meters to 21 meters). In other words, for each pixel in the left camera image, the stereo matching method looks for the best matching pixel in the right camera image over all possible disparities in a second range (e.g., a disparity between 10 and 3). This search may be restricted to the upper portion of the intensity images (depending upon camera mounting positions) as regions at 21 meters and greater downrange generally occur only in the upper portion of the image. The dual baseline stereo camera system 102 may be utilized to create a single stereo range map with unique downrange measurements for every pixel corresponding to intensity pixel locations.

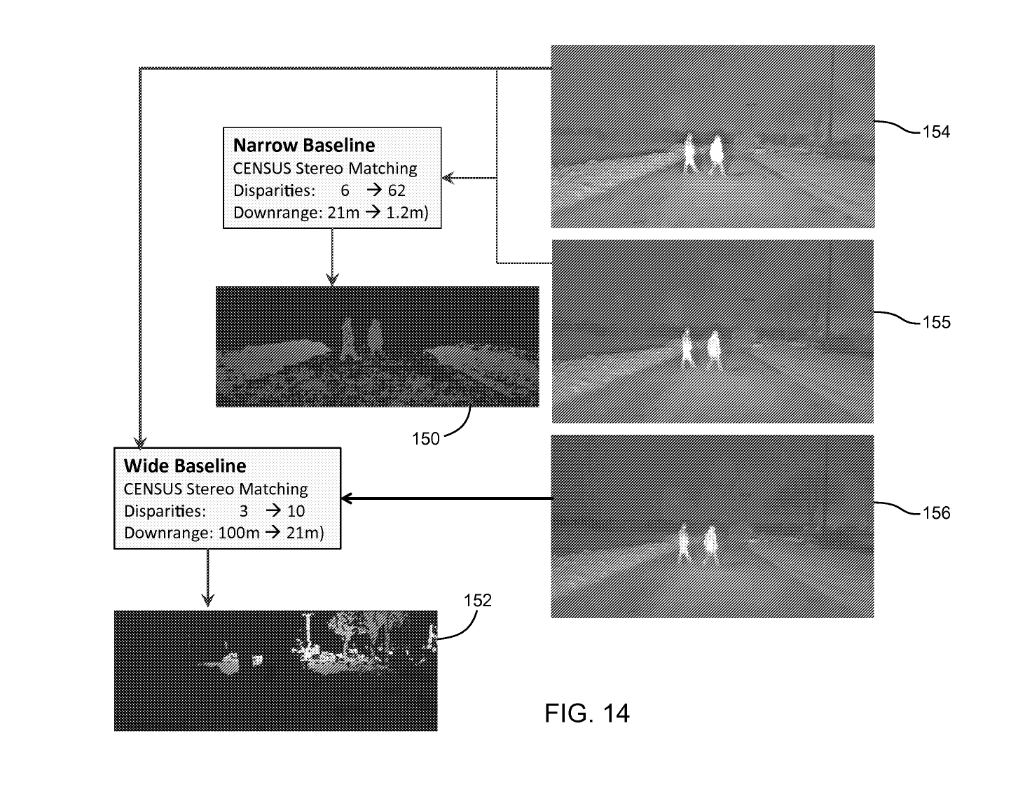

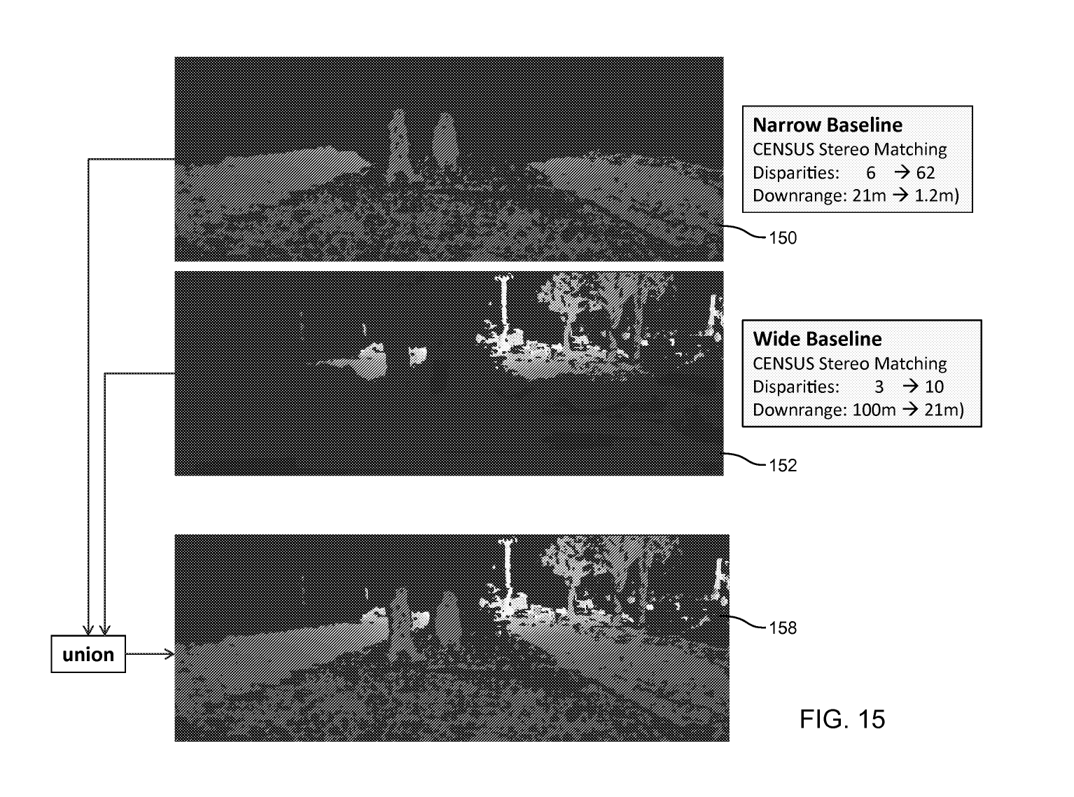

Referring to FIGS. 14-15, an example output of the dual baseline stereo camera system is shown. A first range map 150 is computed from stereo matching the intensity images acquired from the left camera image 154 and the center camera image 155. A second range map 152 is computed from stereo matching the left camera image 154 and right camera image 156. The first range map 150 and the second range map 152 may be combined into a single range map 158.

Another alternative embodiment of the present disclosure may be a hybrid camera system including a pair of cameras operating in the visible band (with minor additional in infrared to 1050 nm), and a center camera in the SWIR band as described above. According to an exemplary embodiment, the two cameras operating in the visible band are capable of sensing energy in a first wavelength interval (e.g., a wavelength interval from 0.4 to 1.1 microns (400 to 1100 nanometers)). The cameras' focal plane array may be constructed from common CMOS technology. According to an exemplary embodiment, the center camera operating in the SWIR band is capable of sensing energy in a second wavelength interval (e.g., a wavelength interval from 0.9 to 1.8 microns), as described above.

The imagery resulting from the use of the SWIR camera of the hybrid camera system may be used to confirm the information obtained from the cameras operating in the visible band. The SWIR camera has different spectral properties than the CMOS cameras. Therefore, the imagery from the SWIR camera may not confirm information as well with environmental colors that reflect well in the infrared, such as red.

However, black clothing (and other black materials) reflect well in the infrared. Thus, the SWIR camera can “see” black clothing much better at night, since common halogen headlights have significant power in the infrared since they are almost blackbody radiation. The black objects detected by the SWIR camera are a significant addition to the objects detected by the CMOS cameras. The use of the SWIR camera allows the image processor to more clearly display the black materials and the object detection system to more easily detect the objects.

SWIR imagery with active SWIR illumination can be fused with the information from the CMOS stereo cameras to improve the CMOS stereo camera performance. The CMOS camera sensors may have about ⅙ sensitivity of the peak at 900 mm and decreases to near zero above 1050 nm, resulting in an increased signal strength. There may be an advantage when the normal headlight is in low beam, since the SWIR illumination is invisible and therefore can illuminate a pattern similar to visible high beams. Therefore, the top portion of pedestrians, close vehicles, and other object are illuminated for the stereo vision system.

With SWIR illumination, the SWIR camera sensor has larger signals and can be a better confirmation or validation check for the visible CMOS stereo system. According to another exemplary embodiment, a thermal infrared sensor/camera may be used instead of the SWIR sensor. For example, a long-wave infrared sensor that allows detection of self-luminous infrared radiation from objects may be used. This type of thermal infrared sensor detects radiation from objects which radiate in this thermal range since the objects are at non-absolute zero temperatures. Living beings typically radiate around 10 microns wavelength. Vehicles and infrastructure radiate at shorter wavelengths as they get hotter. Either an SWIR or a thermal infrared camera may be used in the center location of the stereo vision system.

The stereo sensors and the infrared sensor can work together to enhance the night vision capability of the stereo vision system. As one example, sensor fusion can be used to fuse information extracted from cameras sensing in different spectrum bands. In order to capture the same scene at each time instance, sensors are typically aligned so that their lines of sight are parallel with each other. Sensor calibration is often a necessary step to remove lens distortion in the images and to meet the epipolar constraint for stereo matching. The geometric relations between the infrared sensor and the stereo sensors (relative positions and rotations) can also be precisely calculated during calibration, so that the sensing spaces of the two different sensors can be accurately related mathematically.

Sensor fusion can occur in different ways and at different levels. In one embodiment, sensor fusion may occur at the raw signal level. If the stereo sensors and the infrared sensor have the same spatial resolution (angular degree per pixel) in both the horizontal and vertical directions, then the infrared image can be registered to the left and right stereo images. Registration of the rectified images allows the infrared image to be merged with the left and right stereo images to improve signal to noise ratio in the stereo images. This approach combines the stereo sensors and the infrared sensor at the image level and assumes that objects reflect or irradiate energy in both the visible light spectrum and the infrared spectrum.

In another embodiment, sensor fusion may occur at the range map level. If the stereo sensors and the infrared sensor have the same spatial resolution (angular degree per pixel) in both the horizontal and vertical directions, then the infrared image can be registered to the left stereo image. Assuming the stereo range map is referenced to the left stereo image, the infrared image can then be combined with the range map, filling holes and missing parts in the range map based on infrared image segmentation. This approach also assumes that objects reflect or irradiate energy in both the visible light spectrum and the infrared spectrum.

In another embodiment, sensor fusion may occur at the detection level. The infrared sensor herein may also be replaced by a non-image forming technology, such as LIDAR or radar, or other technology that provides range information. Object detection and segmentation may be conducted separately in stereo range maps and the infrared images, or other ranging technology. Three-dimensional locations of detected objects may also be calculated separately based on available information from each sensor. Depending on the scene to be sensed, sensor fusion may happen in various ways.

For example, if an object is fully or partially detected by the stereo sensor, then the stereo detection can serve as a cue in infrared image based object detection and segmentation, and the downrange of the detected object can be directly obtained from the stereo detection. This is especially helpful when part of the object is missing from the stereo range map (e.g. black pants of a pedestrian at night).

If an object is only detected by the infrared sensor or non-CMOS ranging technology, then the infrared or non-CMOS detection is the output of the fusion process, and the stereo sensor can provide dynamic pitch angle calculation of the three camera sensors based on range information of the flat road surface immediately in front of the host vehicle. The dynamic pitch information enables an accurate downrange calculation of the detected object in the infrared image or non-CMOS data. In this case, the infrared or non-CMOS sensor plays a critical role in detecting dark objects that cannot be seen in the visible light spectrum.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data, which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A stereo vision system for use in a vehicle, the stereo vision system comprising:
a first camera sensor configured to sense first reflected energy and generate first sensor signals based on the sensed first reflected energy;
a second camera sensor configured to sense second reflected energy and generate second sensor signals based on the sensed second reflected energy; and
a processor configured to receive the first sensor signals from the first camera sensor and configured to receive the second sensor signals from the second camera sensor,
wherein the processor is configured to perform stereo matching based on the first sensor signals and the second sensor signals,
wherein the first camera sensor is configured to sense reflected energy that is infrared radiation, and
wherein the second camera sensor is configured to sense reflected energy that is infrared radiation.

2. The stereo vision system of claim 1,
wherein the processor is configured to perform the stereo matching by producing a stereo range map,
wherein the processor is configured to perform object detection using the stereo range map,
wherein the processor is configured to perform object tracking using a result of the object detection, and
wherein the processor is configured to provide an output signal based on a result of the object tracking in order to provide assistance to a driver of the vehicle.

3. The stereo vision system of claim 1,
wherein the first camera sensor is configured to sense reflected energy that is short-wavelength infrared radiation, and
wherein the second camera sensor is configured to sense reflected energy that is short-wavelength infrared radiation.

4. The stereo vision system of claim 1,
wherein an energy sensitive area of the first camera sensor is constructed using indium gallium arsenide, and
wherein an energy sensitive area of the second camera sensor is constructed using indium gallium arsenide.

5. The stereo vision system of claim 1,
wherein the stereo vision system does not include an active illumination component for emitting electromagnetic radiation that can be sensed by the stereo vision system upon reflection off of objects in an environment sensed by the stereo vision system.

6. The stereo vision system of claim 1,
wherein the stereo vision system does not include a component for emitting infrared radiation.

7. The stereo vision system of claim 1, the stereo vision system further comprising:
an active illumination component configured to emit infrared radiation.

8. The stereo vision system of claim 7,
wherein the active illumination component is configured to alternate between emitting infrared radiation and not emitting infrared radiation, and
wherein the active illumination component is configured to emit infrared radiation in synchronization with an exposure interval of the first camera sensor and an exposure interval of the second camera sensor.

9. The stereo vision system of claim 7,
wherein the active illumination component comprises:
one or more laser diodes configured to emit infrared radiation in one or more collimated beams; and
one or more optical filters configured to produce one or more diffused conic beams from the one or more collimated beams.

10. The stereo vision system of claim 9,
wherein the one or more laser diodes comprises:
a first laser diode configured to emit infrared radiation in a first collimated beam;
a second laser diode configured to emit infrared radiation in a second collimated beam; and
a third laser diode configured to emit infrared radiation in a third collimated beam,
wherein the one or more optical filters comprises:
a first optical filter configured to produce a first diffused conic beam at a first dispersion angle from the first collimated beam;
a second optical filter configured to produce a second diffused conic beam at a second dispersion angle from the second collimated beam; and
a third optical filter configured to produce a third diffused conic beam at a third dispersion angle from the third collimated beam,
wherein the first dispersion angle is different from the second dispersion angle and the third dispersion angle, and
wherein the second dispersion angle is different from the third dispersion angle.

11. The stereo vision system of claim 1, the stereo vision system further comprising:
a third camera sensor configured to sense third reflected energy and generate third sensor signals based on the sensed third reflected energy,
wherein the processor is configured to receive the third sensor signals from the third camera sensor, and
wherein the third camera sensor is configured to sense reflected energy that is infrared radiation.

12. The stereo vision system of claim 11,
wherein the second camera sensor is positioned between the first camera sensor and the third camera sensor,
wherein the processor is configured to perform first stereo matching based on the first sensor signals and the second sensor signals but not the third sensor signals, and
wherein the processor is configured to perform second stereo matching based on the second sensor signals and the third sensor signals but not the first sensor signals.

13. The stereo vision system of claim 12,
wherein the processor performs the first stereo matching for a first downrange distance range having a first minimum downrange distance and a first maximum downrange distance,
wherein the processor performs the second stereo matching for a second downrange distance range having a second minimum downrange distance and a second maximum downrange distance, and
wherein the first minimum downrange distance is substantially the same as the second minimum downrange distance.

14. The stereo vision system of claim 12,
wherein the processor is configured to perform first object tracking based on a result of the first stereo matching but not based on a result of the second stereo matching, and
wherein the processor is configured to perform second object tracking based on a result of the second stereo matching but not based on a result of the first stereo matching.

15. The stereo vision system of claim 14,
wherein the processor is configured to perform merging of a result of the first object tracking and a result of the second object tracking.

16. The stereo vision system of claim 11,
wherein the second camera sensor is positioned between the first camera sensor and the third camera sensor,
wherein the processor is configured to perform first stereo matching based on the first sensor signals and the second sensor signals but not the third sensor signals, and
wherein the processor is configured to perform second stereo matching based on the first sensor signals and the third sensor signals but not the second sensor signals.

17. The stereo vision system of claim 16,
wherein the processor performs the first stereo matching for a first downrange distance range having a first minimum downrange distance and a first maximum downrange distance,
wherein the processor performs the second stereo matching for a second downrange distance range having a second minimum downrange distance and a second maximum downrange distance, and
wherein the first maximum downrange distance is substantially the same as the second minimum downrange distance.

18. The stereo vision system of claim 16,
wherein the processor is configured to perform merging of a result of the first stereo matching and a result of the second stereo matching.

19. The stereo vision system of claim 18,
wherein the processor performs the merging by performing a union of a first stereo range map resulting from the first stereo mapping and a second stereo range map resulting from the second stereo mapping.

20. A stereo vision system for use in a vehicle, the stereo vision system comprising:
a first camera sensor configured to sense first reflected energy and generate first sensor signals based on the sensed first reflected energy;
a second camera sensor configured to sense second reflected energy and generate second sensor signals based on the sensed second reflected energy;
a third camera sensor configured to sense third energy and generate third sensor signals based on the sensed third reflected energy; and
a processor configured to receive the first sensor signals from the first camera sensor, configured to receive the second sensor signals from the second camera sensor, and configured to receive the third sensor signals from the third camera sensor,
wherein the processor is further configured to perform stereo matching based on at least one of the first sensor signals, the second sensor signals, and the third sensor signals,
wherein the first camera sensor is configured to sense reflected energy that is visible radiation,
wherein the second camera sensor is configured to sense reflected energy that is visible radiation,
wherein the third camera sensor is configured to sense energy that is infrared radiation.

21. The stereo vision system of claim 20,
wherein the third camera sensor is configured to sense energy that is thermal emitted energy.

22. The stereo vision system of claim 20,
wherein the processor is configured to perform merging of the first sensor signal, the second sensor signals, and the third sensor signals after performing image rectification but prior to performing stereo matching.

23. The stereo vision system of claim 20,
wherein the processor is configured to perform combining of the first sensor signal, the second sensor signals, and the third sensor signals after performing image rectification but prior to performing stereo matching.

24. The stereo vision system of claim 20,
wherein the processor is configured to perform stereo matching based on the first sensor signals and the second sensor signals in order to produce a stereo range map, and
wherein the processor is configured to perform combining of the third sensor signals with the stereo range map.

25. The stereo vision system of claim 20,
wherein the processor is configured to perform first stereo matching based on the first sensor signals and the second sensor signals,
wherein the processor is configured to perform first object tracking based on a result of the first stereo matching,
wherein the processor is configured to perform second object tracking based on the third sensor signals, and
wherein the processor is configured to perform combining of a result of the first object tracking and a result of the second object tracking.

26. A method for stereo vision in a vehicle, the method comprising:
sensing first reflected energy using a first camera sensor;
generating first sensor signals based on the sensed first reflected energy;
sensing second reflected energy using a second camera sensor;
generating second sensor signals based on the sensed second reflected energy; and
performing stereo matching based on the first sensor signals and the second sensor signals,
wherein the first reflected energy is infrared radiation, and
wherein the second reflected energy is infrared radiation.
